(19) United States
(12) Patent Application Publication
(10) Pub. No.: US 2008/0299401 A1
(43) Pub. Date: Dec. 4, 2008

(54) CONDUCTIVE SENSING ELEMENTS FOR APPLICATIONS IN CORROSIVE ENVIRONMENTS

(76) Inventor: Jesus Carmona Valdes, Juarez (MX)

Correspondence Address: DELPHI TECHNOLOGIES, INC., M/C 480-410-202, PO BOX 5052, TROY, MI, 48007, US

(21) Appl. No.: 11/757,027

(22) Filed: Jun. 1, 2007

(51) Int. Cl. B05D 5/12; B32B 15/04

(52) U.S. Cl. 428/472.2; 427/125

(57) ABSTRACT

An improved structure for use in a sensor includes an electrically conductive sensing element that provides improved durability in corrosive environments (ethanol, gasoline, etc.). A substrate may be formed using either ceramic or an anodized carrier of aluminum. In either case, the substrate presents an electrically insulating surface layer on which an electrically conductive sensing element may be formed. The conductive element is formed by thick film aluminum ink printing the desired shape (and thickness) of the element on the substrate, then firing the resulting structure. Thereafter, the entire structure, now with aluminum conductive elements, is anodized in order to form a protective and electrically insulative coating of a desired thickness. Another structure includes a base element or trace comprising an alloy of silver and palladium. An aluminum trace overlays the base element, and is thereafter anodized throughout its thickness to provide a protective layer.

### TECHNICAL FIELD

The present invention relates generally to conductive sensing elements for applications in corrosive environments.

### BACKGROUND OF THE INVENTION

Sensors having different sensing technologies are known that require having their sensing elements directly exposed to corrosive influences (i.e., a “corrosive environment”). Adequate protection of these elements is important to ensure the integrity and performance of the sensor during its operating life. Such protection is especially important for technologies that use conductive (e.g., metal based) sensing elements where the corrosive environment itself promotes oxidation of the metal-based sensing elements. For example, corrosive environments may involve corrosive chemicals such as ethanol, gasoline and the like.

A number of anti-corrosion approaches have thus been developed. Conventional approaches typically involve applying a highly chemical resistant coating to protect the element at risk for oxidation. Such coatings include paralyene-C, epoxy based coatings and other thermoplastic or thermoset polymeric coatings. However, this approach has some limitations. For example, for some applications factors such as cost and coating thickness prevent the use of coating as described above. Moreover, even with such a coating, resistance to corrosion is not guaranteed or perfect for solvents such as ethanol, and in any event the likelihood of oxidation or corrosion increase over time (i.e., as the length of time increases that the corrosive chemical is in contact with the coating).

There is therefore a need for a method for fabricating conductive sensing elements that minimizes or eliminates one or more of the problems set forth above.

### SUMMARY OF THE INVENTION

One advantage of the present invention is that it provides a structure for conductive sensing elements (i.e., electrodes) that is highly resistant to corrosive influences such as various solvents (e.g., ethanol, gasoline, etc.), relatively inexpensive to make, and highly stable due to its ability to self-passivate, thereby inhibiting further corrosion.

A method for fabricating a conductive sensing element comprises three basic steps. The first step involves providing an insulating substrate. In one embodiment, this step is performed by providing a substrate of an insulating material such as ceramic. In an alternate embodiment, this step is performed by providing a carrier made of aluminum, and then forming an insulating and protective layer thereon by anodization.

The second step of the method involves providing an electrically conductive sensing element on the insulating substrate wherein the conductive element comprises aluminum. In one embodiment, this may be performed by printing a thick-film ink containing aluminum into a desired pattern, and then firing the assembly as per known thick film fabrication processes. This results in an aluminum sensing element, in a preferred embodiment.

The final step involves anodizing the conductive element so as to form an insulating layer of aluminum oxide on the conductive element. The insulating layer formed through anodization of aluminum also operates as a protective layer, preventing further corrosion (i.e., oxidation) of the metal conductive sensing element. In one embodiment, such aluminum oxide layer may be between about 5 and 50 μm thick.

In an alternate embodiment, aluminum ink, subsequently anodized, is used to protect thick film traces made of another metal (not aluminum), such as Silver-Palladium alloys.

Other features and aspects of the invention are also presented.

### BRIEF DESCRIPTION OF THE DRAWINGS

The present invention will now be described by way of example, with reference to the accompanying drawings:

FIG. 1 is a top plan view of a structure according to the invention for a ceramic substrate embodiment.

FIG. 2 is a cross-sectional view taken substantially along lines 2-2 in FIG. 1 showing the stack up of the sensing element on the ceramic substrate.

FIG. 3 is a top plan view of a structure according to the invention for an anodized aluminum substrate embodiment.

FIG. 4 is a cross-sectional view taken substantially along lines 4-4 in FIG. 3 showing the stack up of the sensing element on the anodized aluminum substrate.

FIG. 5 is a flow chart diagram of a method of making a conductive sensing element in accordance with the invention.

FIG. 6 is a top plan view of a structure according to a still further embodiment having a non-aluminum conductive trace overlayed with an anodized aluminum protective layer.

FIG. 7 is a cross-sectional view taken substantially along lines 7-7 in FIG. 6 showing the stack up of the non-aluminum, conductive sensing element overlayed with a protective coating of anodized aluminum.

### DETAILED DESCRIPTION OF THE PREFERRED EMBODIMENT

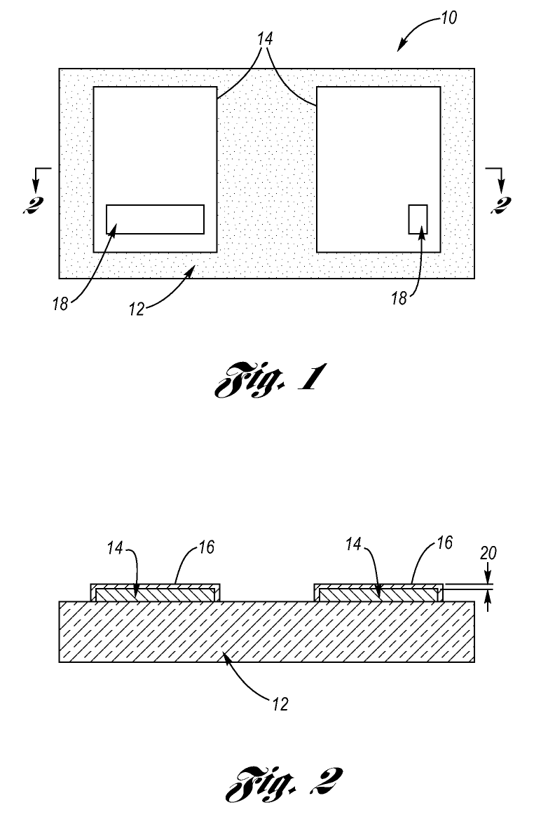

Referring now to the drawings wherein like reference numerals are used to identify identical components in the various views, FIG. 1 is a top plan view of a structure 10 configured to have conductive sensing elements suitable for use in corrosive environments, as described in the Background. In accordance with the present invention, such structure 10 is formed using thick film fabrication techniques, and importantly has an anodized aluminum protection layer to inhibit corrosion in corrosive environments.

As further background, the thick-film circuit is one well-known form of monolithic integrated microelectronic circuit. Circuits of this type are particularly useful where a large number of passive components are required, or where moderately high power dissipation is required. Thick-film circuits are less costly to produce can yield a broader range of resistance values than thin-film circuits.

The manufacture of thick-film circuits is a refinement of the ancient art of silk-screen printing. Thick-film circuits consist of patterns of conductors, resistors and other passive circuit components printed on a particular substrate. In most known processes, a variety of inks are applied onto a substrate or successive circuit layers through a screen or a template of a specific printed pattern. The successive layers are dried after printing and fired in a conveyor furnace to fix the material.

The application of conductive layers in a thick-film circuit is frequently referred to as thick-film metallization. The metallization process for the traditional thick-film substrate materials, such as alumina, has been fairly well developed throughout the years by refinement of the conductive inks, improvement of the application process and optimization of firing times, temperatures and atmospheres. These and other aspects are known and well understood in the art, as seen by reference to U.S. Pat. No. 6,150,041 entitled “THICK-FILM CIRCUITS AND METALLIZATION PROCESS” issued to Lautzenhiser et al, assigned to Delphi Technologies, Inc., the common assignee of the present invention, and hereby incorporated by reference.

With reference now to FIGS. 1 and 2, structure 10 includes an insulating substrate 12, at least one conductive element 14 (two shown) comprising aluminum material, each conductive element 14 having a respective protective layer 16, and at least one electrically conductive pad or the like 18.

Structure 10 is of the type that is suitable for use in sensing applications expected to be used in corrosive environments. Generally, this type of structure is suited for capacitive sensors in which the plates of the capacitive structure have to be directly exposed to corrosive fluids, for example gasoline and ethanol. This structure also applies to any other sensors that require sensing an electric field in a way that the sensing plate is exposed to corrosive liquids. More specifically, one application of the invention may be for a fuel level sensor and another may be for an Ethanol concentration sensor. Both sensor applications are based on capacitive technology, where the dielectric of the capacitor is the actual fuel. Therefore, for acceptable performance, the capacitor plates must be as close as possible to the fuel. This means that the layer used to protect and insulate such plates must be as thin as possible. Conventionally, to give adequate protection, polymer coatings have to have a relatively high thickness (e.g. 400 microns), which disadvantage is overcome by the present invention.

Substrate 12 in the illustrative embodiment is formed of ceramic material throughout its thickness. Ceramic material forms a dimensionally rigid carrier and has electrical insulating properties, as known in the art.

The conductive sensing element or traces 14 are preferably formed of aluminum or its alloys. Aluminum is a good electrical conductor. In a preferred embodiment, the conductive elements 14 are formed by printing aluminum thick film ink or paste directly onto substrate 12 in a desired pattern and amount and then fired or otherwise cured to obtain a finished, desired geometry and thickness. These aspects of the present invention are well known in the art. Aluminum thick film ink may comprise commercially available products, for example only, ink, designated by part no. 2593-P or 2591-E, both available from ESL ElectroScience Labs, King of Prussia, Pa., USA.

Protective layer 16 is formed as a result of anodizing the intermediate structure formed after fabrication of the conductive, sensing element(s) 14. The protective layer 16 in the illustrative embodiment (where element 14 is aluminum) is thus anodized aluminum or aluminum oxide (alumina). The aluminum oxide layer 16 is a strong ceramic that is tightly bonded to the aluminum element 14. This aluminum oxide layer 16 is grown from and into the exposed surface of aluminum sensing element 14. Layer 16 is strongly adherent because it is chemically bonded to the metal surface as compared to, for example, oxidation of other metals such as steel (i.e., rust can easily flake off). Additionally, layer 16 is not prone to peeling or cracking like organic coatings such as paint. Finally, aluminum oxide layer 16 exhibits excellent thermal and electrical insulation properties as well.

In one embodiment, the anodizing process is configured and controlled so that layer 16 has a predetermined, desired thickness, designated in FIG. 2 by reference numeral 20, of between about 5 and 50 μm. Various approaches for anodizing aluminum are known and well documented in the art. Also, it should be appreciated that because the layer 16 is self-passivating, it is self-healing as well. This is another advantage.

The anodizing process of the conductive elements may be implemented, in one embodiment, by disposing the structure in a bath of chromic or oxalic acid. Next, applying a DC voltage (e.g., in the range of 12V to 24V), where the conductive elements would work as the anode of the DC voltage circuit. The processing time would be determined as a function of the bath used, concentration, layer 16 thickness, etc., all as known in the art.

It should be understood that structure 10 may be used in sensing applications and accordingly it is contemplated that structure 10, specifically, conductive sensing elements 14, will be electrically connected to external circuitry. Therefore, in a further feature of the invention, pads or points 18 are provided on conductive elements 14. However, aluminum oxide, as known, is difficult to solder (e.g., for an external connection). Accordingly, pads 18 that are destined for soldering are preferably covered with a suitable, but stable (i.e., relatively impervious to anodizing and relatively corrosion resistant in the contemplated corrosive environment), ink comprising a metal such as gold or tin, before the anodization process. In this way, the pads 18 will not only remain suitable for soldering, but will endure in the contemplated corrosive environment.

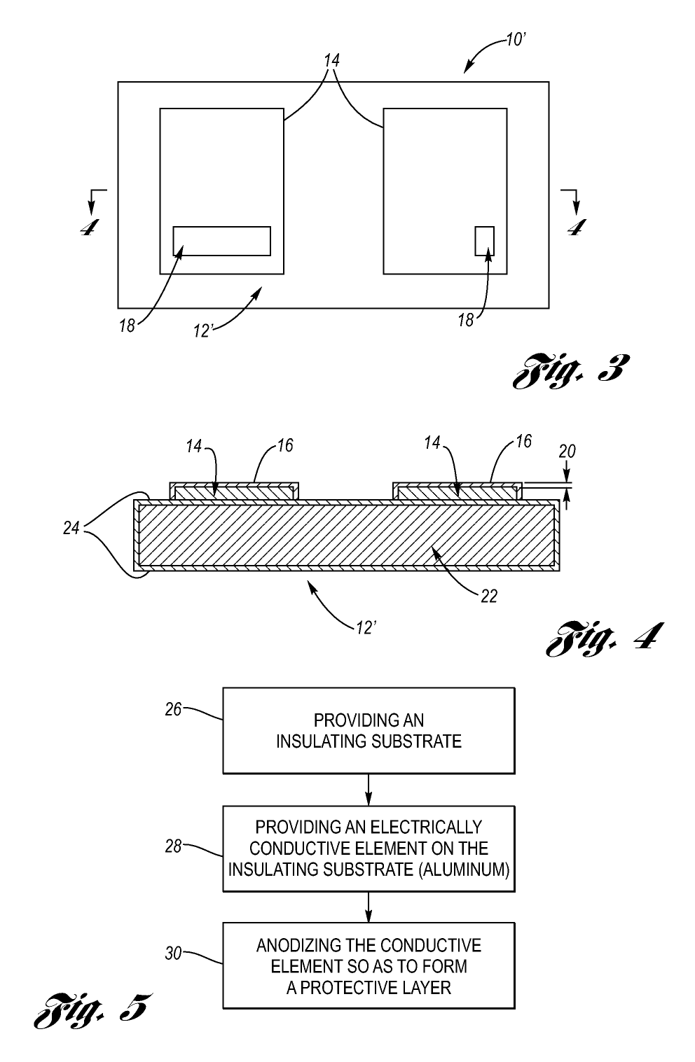

FIG. 3 is a top plan view of a structure 10′ in an alternate, anodized aluminum substrate embodiment.

FIG. 4 is a cross-sectional view of the structure 10′ taken substantially along lines 4-4 in FIG. 3.

With continued reference to FIGS. 3 and 4, structure 10′ includes an insulating substrate 12′ that includes an aluminum carrier 22 that has been previously anodized to produce an anodized layer 24 of aluminum oxide. As described above, such an aluminum oxide layer has excellent durability (resistance to corrosion) and additionally is an excellent electrical insulator. Accordingly, it services the same function as ceramic insulating substrate 12 described above (i.e., suitable for disposing directly thereon electrically conductive sensing element(s) 14). In all other respects, structure 10′ is the same as structure 10 and a detailed description thereof may be had by reference to the description above regarding structure 10.

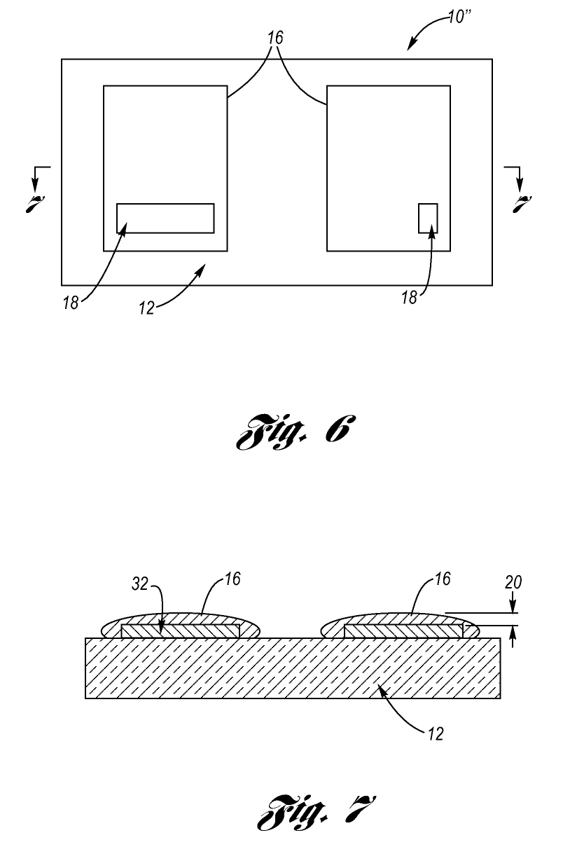

FIG. 5 is a flowchart describing a method of making or fabricating a conductive sensing element. The method includes three basic steps.

First step 26 involves providing an insulating substrate. In one embodiment, this step is performed by providing a substrate of an insulating material such as ceramic. In an alternate embodiment, this step is performed by providing a carrier made of aluminum, and then forming an insulating and protective layer thereon by anodization.

Second step 28 of the method involves providing an electrically conductive sensing element on the insulating substrate wherein the conductive element comprises aluminum. In one embodiment, this may be performed by printing a thick-film ink containing aluminum into a desired pattern, and then firing the assembly as per known thick film fabrication processes. This results in an aluminum sensing element, in a preferred embodiment.

The final step 30 involves anodizing the conductive element so as to form an insulating layer of aluminum oxide on the conductive element. The insulating layer formed through anodization of aluminum also operates as a protective layer, preventing further corrosion (i.e., oxidation) of the metal conductive sensing element. In one embodiment, such aluminum oxide layer may be between about 5 and 50 μm thick.

FIGS. 6 and 7 illustrate a still further embodiment of the present invention. In this alternate embodiment, aluminum ink (subsequently anodized) can be used to protect thick film conductive elements made of another metal such as Silver-Palladium alloys.

FIG. 6 shows a structure 10″ that includes an insulating substrate 12, at least one conductive base element 32 (two are shown) comprising a conductive metal or metal alloy, such as, but not limited to, that described above (e.g., alloy of Silver and Palladium). For example, U.S. Pat. No. 6,150,041 entitled “THICK-FILM CIRCUITS AND METALLIZATION PROCESS” issued to Lautzenhiser et al., assigned to the common assignee of the present invention, teach a silver-palladium composition suitable for thick film metallization.

Each electrically-conductive base element 32 has a respective protective layer 16, comprising in final form anodized aluminum, and at least one electrically conductive pad or the like 18.

FIG. 7 is a cross-sectional view taken substantially along lines 7-7 in FIG. 6.

In construction, base elements 32 are formed by printing on substrate 12 corresponding base traces using suitable thick film inks. Thereafter, protective layer 16 is formed by applying a protective trace comprising thick film aluminum ink on top of the base traces. The step of applying the protective trace can be done before or after firing of the base conductive trace, depending on the material composition of the base trace and its firing temperature compatibility with aluminum traces.

Next, the structure 10″ is fired, as known in the art. As with the embodiments described above, the aluminum thick film traces will tightly bond to the base traces during the firing process, thereby forming the conductive base element 32 and an overlying layer of aluminum.

After this firing step, the aluminum, protective traces are anodized, forming a protective, insulating layer 16 to protect the underlying conductive base element 32.

A thickness 20 of protective layer 16 can be controlled during the anodizing process. Preferably, thickness 20 of layer 16 is as close as possible to that described in connection with the embodiments of FIGS. 1-4, namely, between about 5 and 50 μm. Additionally, it is also preferable that in the embodiment of FIGS. 6-7, the entire thickness of the aluminum layer be anodized. This somewhat different from the embodiments of FIG. 1-4, where the aluminum element performed two functions: (i) a first function relating to electrical conduction; and (ii) a second function relating to protection of the conductive element from corrosive influences, as well as electrical insulation, by encapsulation in an outer, anodized aluminum protective layer 16. In the embodiment of FIGS. 6-7, however, the anodized aluminum layer 16 only has to perform the function of electrical insulation and protection from corrosive influences, since the electrical conduction function is performed by the base element 32 comprising a conductive material other than aluminum (e.g., silver/palladium alloy).

To allow for soldering, spots on the base element 32 could be masked to prevent the aluminum ink from covering them, just as in the embodiments of FIG. 1-4, forming pads 18. Depending on specific requirements, these spots could be covered with gold or other corrosive resistant material that allows for soldering, or such spots could just be left without modification, exposing the base conductive elements 32 for soldering or other electrical connection.

While particular embodiments of the invention have been shown and described, numerous variations and alternate embodiments will occur to those skilled in the art. Accordingly, it is intended that the invention be limited only in terms of the appended claims.

1. A method for fabricating a conductive sensing element comprising the steps of:
providing an insulating substrate;
providing an electrically conductive element on the insulating substrate wherein the conductive element comprises aluminum;
anodizing the conductive element so as to form an insulating layer of aluminum oxide on the conductive element.

2. The method of claim 1 wherein said anodizing step is further performed until the insulating layer is between about 5 and 50 μm.

3. The method of claim 1 wherein said step of providing the insulating substrate includes the substep of:
forming the substrate using ceramic material substantially throughout its thickness.

4. The method of claim 1 wherein said step of providing the insulating substrate includes the substeps of:
forming a carrier comprising aluminum material;
anodizing the carrier to form a surface layer on the carrier thereby producing the insulating substrate wherein the surface layer comprises aluminum oxide material.

5. The method of claim 1 wherein said step of forming the electrically conductive element includes the substeps of:
printing aluminum thick film ink onto the substrate wherein the thick film ink comprises aluminum; and
firing the printed thick film ink to produce the electrically conductive element.

6. The method of claim 1 further comprising the steps of:
forming a pad on the conductive element configured for electrical connection.

7. The method of claim 6 further including the steps of:
selecting one from a group of stable, conductive metals that are substantially impervious to anodizing; and
before said anodizing step, overlaying on said pad an ink comprising the selected one metal and curing said ink.

8. The method of claim 7 wherein said metal group comprises gold and tin.

9. A structure comprising:
an electrically insulating substrate;
at least one conductive element comprising aluminum formed directly on said substrate, said conductive element have an exposed surface;
at least one pad of a metal selected from the group comprising gold and tin formed directly on said conductive element;
an anodized layer of aluminum oxide on and in said outer, exposed surface of said at least one conductive element.

10. The structure of claim 9 wherein said layer of aluminum oxide is between about 5 and 50 μm.

11. A method for fabricating a conductive sensing element comprising the steps of:
providing an insulating substrate;
providing an electrically conductive base element on the insulating substrate wherein the conductive base element comprises a conductive metal alloy;
forming an protective layer overlaying the base element, said protective layer comprising aluminum material; and
anodizing the protective layer so as to form an insulating layer of aluminum oxide on the conductive base element.

12. The method of claim 11 wherein said anodizing step is further performed until the insulating layer is between about 5 and 50 μm, and extends substantially throughout and coextensive with the thickness of the protective layer.

13. The method of claim 11 wherein said step of providing the insulating substrate includes the substep of:
forming the substrate using ceramic material substantially throughout its thickness.

14. The method of claim 11 wherein said step of providing the insulating substrate includes the substeps of:
forming a carrier comprising aluminum material;
anodizing the carrier to form a surface layer on the carrier thereby producing the insulating substrate wherein the surface layer comprises aluminum oxide material.

15. The method of claim 11 wherein said step of forming the electrically conductive base element includes the substeps of:
printing a conductive metal or metal alloy thick film ink onto the substrate wherein the thick film ink comprises a conductive metal or alloy thereof; and
firing the printed thick film ink to produce the electrically conductive base element.

16. The method of claim 11 further comprising the steps of:
forming a pad on the conductive base element configured for electrical connection.

17. The method of claim 16 further including the steps of:
selecting one from a group of stable, conductive metals that are substantially impervious to anodizing; and
before said anodizing step, overlaying on said pad an ink comprising the selected one metal and curing said ink.

18. The method of claim 17 wherein said metal group comprises gold and tin.

19. The method of claim 11 wherein the conductive metal alloy of the base sensing element comprises an alloy of silver and palladium.
